(19) United States
(12) Patent Application Publication
(10) Pub. No.: US 2006/0078102 A1
(43) Pub. Date: Apr. 13, 2006

(54) Door answering system

(76) Inventor: Peter Giannakouros, Brooklyn, NY (US)

Correspondence Address: JAMES RAY & ASSOCIATES, 2640 PITCAIRN ROAD, MONROEVILLE, PA, 15146, US

(21) Appl. No.: 11/248,673

(22) Filed: Oct. 12, 2005

Related U.S. Application Data
(60) Provisional application No. 60/617,923, filed on Oct. 12, 2004.

(51) Int. Cl. H04M 9/00; H04M 1/60

(52) U.S. Cl. 379/167.05; 379/167.01

(57) ABSTRACT

A door bell answering system for a dwelling includes an internally disposed answering device which has a housing, a control member capable of at least storing and playing an audio message, a speaker for broadcasting the audio message and a predetermined plurality of function keys manually operable from an exterior surface of the housing for operating the control member and the speaker. An externally disposed panel has a housing mounted to an exterior surface of the dwelling, a microphone disposed within the housing, a first switch for activating a door bell, a second switch for activating the answering device and the microphone and for enabling a visitor to record the audio message. The control panel and the answering device are connected by wires for transmitting the audio message therebetween.

### CROSS-REFERENCE TO RELATED APPLICATIONS

This application is related to and claims priory from U.S. Provisional Patent Application Ser. No. 60/617,923 filed Oct. 12, 2004.

### FIELD OF THE INVENTION

The present invention relates, in general, to a door bell answering system and, more particularly, this invention relates to a door bell answering system which is capable of recording and playing back messages and, yet more particularly, the instant invention relates to a door bell answering system which additionally enables intercom type communication.

### BACKGROUND OF THE INVENTION

Door bell answering systems are well known in the art to announce presence of a visitor and enable the visitor to leave a message if the occupant of the dwelling is unavailable or does not want to open or unlock the door.

U.S. Pat. No. 4,715,060 to Lipscher et al and U.S. Pat. No. 5,784,446 to Stuart disclose one type of door bell answering system that includes an external control unit connecting external speaker/microphone to an automatic telephone answering and recording machine in response to door bell operation.

U.K. Patent Applications GB 2 285 530 and GB 2 285 831 disclose another type of the door bell answering system that includes an external control panel having a movement detector. U.S. Patent Publication 2004/0095254 to Maruszczak discloses an externally mounted sensor generating a signal in response to presence of a person.

Design complexity of such prior art door bell answering systems increases system costs and decreases reliability of operation.

### SUMMARY OF THE INVENTION

The present invention provides a door bell answering system that includes an internally disposed answering device which has a housing and a control member means capable of at least storing and playing an audio message. A speaker is provided for broadcasting the audio message and a predetermined plurality of function keys are manually operable from an exterior surface of the housing for operating the control member and the speaker. The door bell system further includes an externally disposed panel which has a housing mounted to an exterior surface of a dwelling and a microphone member disposed within the housing. A first switch is manually operable from the exterior surface of the housing for activating a door bell and a second switch is manually operable from the exterior surface of the housing for activating the answering device and the microphone and for enabling a visitor to record the audio message. The control panel and the answering device are connected by wires for transmitting the audio message therebetween.

According to another embodiment of the invention, the door bell activating switch is disposed independently from the externally disposed panel.

### OBJECTS OF THE INVENTION

It is, therefore, one of the primary objects of the present invention to provide a door bell answering system for a dwelling.

Another object of the present invention is to provide a door bell answering system for a dwelling which enables recording and playback of messages.

Yet another object of the present invention is to provide a door bell answering system for a dwelling which is economical to manufacture.

A further object of the present invention is to provide a door bell answering system for a dwelling which enables two-way intercom communication.

Yet a further object of the present invention is to provide a door bell answering system for a dwelling which improves safety of the dwelling's occupant responding to door bell activation.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a partial perspective view of a door bell answering system of the present invention;

FIG. 2 is a perspective view of an answering device of the door bell answering system of the invention;

FIG. 3 is a schematic representation of the door bell answering system according to one embodiment of the invention; and

FIG. 4 is a schematic representation of the door bell answering system according to another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

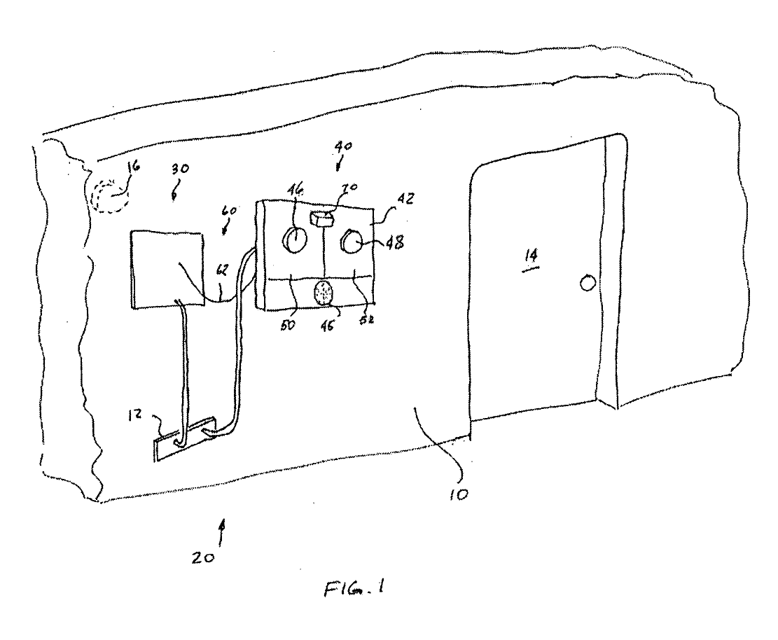

Reference is now made, to FIGS. 1-4, wherein there is shown a door bell answering system, generally designated 20, which comprises an answering device, generally designated 30, internally disposed in a predetermined portion of a dwelling 10 and connected to an electrical power source 12 disposed within such dwelling 10.

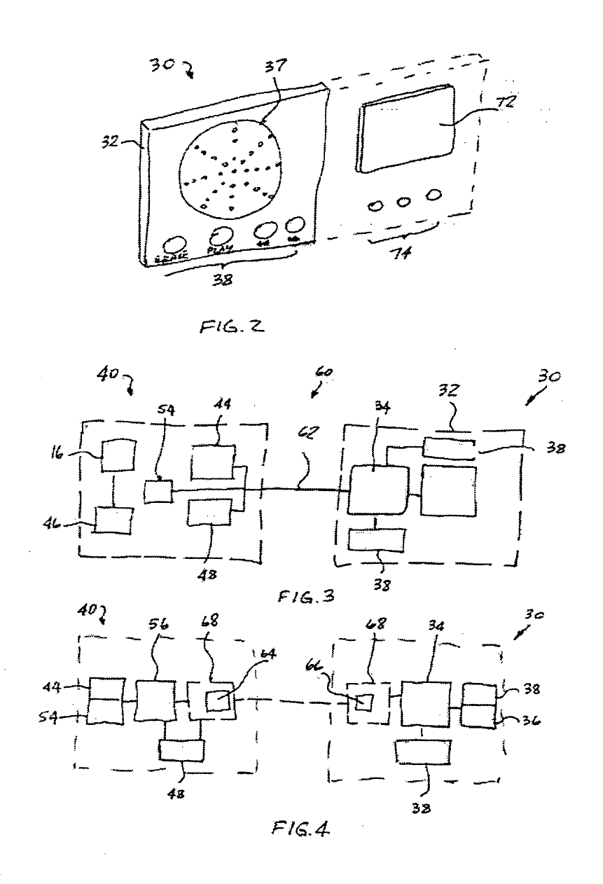

According to one embodiment of the invention, best shown in FIGS. 2-3, the answering device 30 includes a housing 32, a control means 34 capable of at least storing and playing back at least one audio message, a speaker 36, located behind the port 37 of the housing 32, for broadcasting the at least one audio message and a predetermined plurality of function keys 38 manually operable from an exterior surface of the housing 32 for operating the control means 34 and the speaker 36.

The door bell answering system 20 further includes an externally disposed communication means, generally designated 40, preferably connected to such electrical power source 12 and including a housing 42 mounted to an exterior surface of such dwelling 10. The communication means 40 is preferably disposed in close proximity to the door 14 of such dwelling 10. Such communication means 40 further includes a microphone 44, preferably disposed behind a port 45 of the housing 42, a first manually operable switch 46 for activating a door bell 16 which is audibly recognizable internal to such dwelling 10 and a second manually operable switch 48 for activating the answering device 30 and the microphone 44. Preferably, each of the first switch 46 and the second switch 48 is a pushbutton type suitable for operation under undesirable weather conditions such as rain, snow, dust and the like. A visitor, upon depressing, preferably continuously, such second switch 48, is able to record such at least one audio message by speaking into the microphone 44. The visitor may record additional messages by depressing the second switch 48 again.

A first predetermined indicia 50 is provided for characterizing the first manually operable switch 46 and a second predetermined indicia 52 may be provided for characterizing the second manually operable switch 48. Each of such first indicia 50 and second indicia 52 may be disposed on the outer surface of the housing 42 adjacent its respective switch or may be disposed directly on the surface of such respective switch.

Such at least one audio message is transmitted between the communication means 40 and the answering device 30 through a connection means, generally designated 60, which in the presently preferred embodiment of the invention is at least one wire 62, as best shown in FIGS. 1 and 3.

In operation, the visitor will first depress the first switch 46 and wait for an occupant of the dwelling 10 to unlock or open the door 14. If such event does not occur, the visitor then depresses the second switch 48 and speaks in the direction of the microphone 44. The audio message received by the microphone 44 is transmitted thorough the at least one wire 60 to the answering device 30 and is recorded by the control means 34. The occupant then uses the function keys 38 to retrieve the recorded at least one audio message which is broadcast through speaker 36. It will be appreciated that the invention disclosed supra is advantageous when the occupant of the dwelling 10 is not available or not inclined to unlock or open the door 14.

According to another embodiment of the invention, the answering device 30 is provided with a microphone 38 and the communication means 40 is provided with a speaker 54 enabling the visitor and the occupant of such dwelling 10 to audibly communicate in a two-way intercom type communication and further enhance safety of the occupant when the visitor is unfamiliar or an undesirable person.

Those skilled in the art will appreciate that such at least one wire 62 is economical to connect adjacently positioned communication means 40 and the answering device 30, when such answering device 30 is attached to the interior wall portion of dwelling 10, as best shown in FIG. 1. To provide for ease of remote installation of answering device 30, such transmitting means 60 may be a wireless type including a transmitter 64 disposed within the externally disposed communication means 40 and a receiver 66 disposed within the answering device 30. Accordingly, a second control means 56 will be provided within the communication means 40 and the control means 34 will be adapted to enable such wireless communication between the communication means 40 and the answering device 30.

Furthermore, to enable two-way wireless communication, the door bell answering system 20 will be adapted with a pair of transceivers 68, wherein the first transceiver 68 is disposed within the answering system 30 and the second transceiver 68 is disposed within the communication means 40. Accordingly, the control means 34 and 56 will be adapted to enable such two-way wireless communication.

In further reference to FIGS. 1-2 and according to yet another embodiment of the invention, the communication means 40 is provided with a camera 70 and the answering device 30 is provided with a display 72 and, preferably, its respective set of function keys 74 for enabling the occupant of dwelling 10 to visually identify the visitor. It will be understood that a second display 72 may be provided within the communication means 40 and a second camera 70 may be provided within the answering device 30 for enabling the visitor and the occupant of such dwelling 10 to audibly and visually communicate therebetween.

Although the present invention has been shown in terms of the communication means 40 containing the switch 46 for activating door bell 16, it will be apparent to those skilled in the art, that the present invention may be applied to the door bell 16 having an independent activating switch.

Furthermore, the communication means 40 may be adapted with a replaceable battery to minimize installation costs and eliminate connection of such communication means 40 to the power source 12 of the dwelling 10.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A door bell answering system for a dwelling, said door bell answering system comprising:
(a) an answering device internally disposed in a predetermined portion of such dwelling and connected to an electrical power source, said answering device having a housing, a control means capable of at least storing and playing back at least one audio message, a speaker for broadcasting said at least one audio message and a predetermined plurality of function keys manually operable from an exterior surface of said housing for operating said control means and said speaker;
(b) an externally disposed communication means having a housing mounted to an exterior surface of such dwelling, said housing having a port, a microphone disposed within said housing adjacent said port, a manually operable switch for activating said answering device and said microphone and for enabling a visitor to record said at least one audio message; and
(c) means connecting said communication means with said answering device for transmitting said at least one audio message therebetween.

2. The system, according to claim 1, wherein said answering device includes a second microphone and said externally disposed communication means includes a second speaker for enabling two-way audio communication between such visitor and an occupant of such dwelling.

3. The system, according to claim 1, wherein said message transmitting means is at least one wire.

4. The system, according to claim 1, wherein said message transmitting means is a transmitter disposed within said externally disposed communication means and a receiver disposed within said answering device for forming a wireless communication link between said transmitter and said receiver, and whereby said communication means includes a second control means for enabling said wireless communication link.

5. The system, according to claim 1, wherein said message transmitting means is a first transceiver disposed within said externally disposed communication means and a second transceiver disposed within said answering device for forming a wireless link between said transmitter and said receiver, and whereby said communication means includes a second control means for enabling said wireless communication link.

6. The system, according to claim 1, wherein said answering device is attached to an interior wall portion of said dwelling and has a wiring connection to said externally disposed communication means.

7. The system, according to claim 1, wherein said system further includes a predetermined indicia for characterizing said manually operable switch.

8. The system, according to claim 1, wherein said system further includes a door bell audibly recognized internally to such dwelling.

9. The system, according to claim 1, wherein said system further includes a second switch manually operable from said exterior surface of said housing of said communication means for activating a door bell.

10. The system, according to claim 9, wherein said system further includes a second predetermined indicia for characterizing said manually operable second switch.

11. The system, according to claim 1, wherein said system further includes a camera disposed within said communication means and a display disposed within said answering device for enabling an occupant of such dwelling to visually identify such visitor.

12. The system, according to claim 1, wherein said system further includes a first display and a first camera disposed within said communication means and a second display and a second camera disposed within said answering device for enabling a video and an audio communication between such visitor and an occupant of such dwelling.

13. The system, according to claim 1, wherein said communication means is disposed adjacent a door of such dwelling.

14. The system, according to claim 1, wherein said communication means is connected to an electrical power source.

15. The system, according to claim 1, wherein said communication means includes an electrical battery power source.

16. A door bell answering system for a dwelling, said door bell answering system comprising:
(a) a door bell audibly recognizable internally to such dwelling;
(b) an answering device internally disposed in a predetermined portion of such dwelling and connected to an electrical power source, said answering device having a housing, a control means capable of at least storing and playing back at least one audio message, a speaker for broadcasting said at least one audio message and a predetermined plurality of function keys manually operable from an exterior surface of said housing for operating said control means and said speaker;
(c) an externally disposed communication means having a housing mounted to an exterior surface of such dwelling, said housing having a port, a microphone member disposed within said housing adjacent said port, a first manually operable switch for activating said door bell, a second manually operable switch for activating said answering device and said microphone and for enabling a visitor to record said at least one audio message; and
(d) means connecting said communication means with said answering device for transmitting said at least one audio message therebetween.
